(19) United States
(12) Patent Application Publication
(10) Pub. No.: US 2026/0141270 A1
(43) Pub. Date: May 21, 2026

(54) MEMORY DEVICE AND COMPUTING SYSTEM

(71) Applicant: SK hynix Inc., Icheon-si (KR)

(72) Inventor: Myung Hyun RHEE, Icheon-si (KR)

(21) Appl. No.: 19/349,774

(22) Filed: Oct. 3, 2025

(30) Foreign Application Priority Data
Nov. 19, 2024 (KR) 10-2024-0164945
Jun. 5, 2025 (KR) 10-2025-0073313

(51) Int. Cl. G06N 5/04

(52) U.S. Cl. CPC G06N 5/04

(57) ABSTRACT

Embodiments of the present disclosure may provide a processing unit and a computing system that divide computations according to the types of computations performed during an inference computation using an artificial intelligence model and perform the divided computations by separate processing units, thereby being capable of reducing an overall time required for the inference computation and improving the performance of the inference computation.

### CROSS-REFERENCE TO RELATED APPLICATIONS

The present application claims priority under 35 U.S.C. § 119(a) to Korean Patent Application Nos. 10-2024-0164945 filed on Nov. 19, 2024 and 10-2025-0073313 filed on Jun. 5, 2025, which are incorporated herein by reference in their entireties.

### BACKGROUND

### 1. Technical Field

Embodiments of the present disclosure relate to a memory device and a computing system.

### 2. Related Art

A memory device may store data and provide stored data to a processor, according to a request from the processor. The processor may perform a computation using data stored in the memory device, and may store data according to a computation result in the memory device.

Depending on a computation to be performed by the processor, the amount of data to be transmitted and received between the processor and the memory device may increase. In particular, when a computation for learning or inference of an artificial intelligence model is performed by the processor, a computation on a large amount of data may be required.

The performance of the computation for learning or inference of the artificial intelligence model may be expressed as the performance of a system, and a method for efficiently performing such a computation to improve the performance of the system is highly desired.

### SUMMARY

Objects of embodiments of the disclosure are not limited to those set forth herein, and other unmentioned objects would be apparent to one of ordinary skill in the art from the following description.

Embodiments of the present disclosure are directed to providing measures capable of efficiently performing a computation according to an artificial intelligence model, thereby improving a method of providing a computation result by the artificial intelligence model and improving the performance of a system.

In an embodiment, a computing system may include: a first processing unit including at least one first memory device, and a first processor configured to perform a plurality of linear computations based on at least one of a first input value inputted to an artificial intelligence model or a first intermediate value calculated on the basis of the first input value and a previously stored model parameter using the at least one first memory device; and a second processing unit including at least one second memory device, and a second processor configured to perform an attention computation based on at least one of a first computation value calculated by at least some of the plurality of linear computations or a second intermediate value calculated on the basis of the first computation value using the at least one second memory device and provide a second computation value according to the attention computation.

In an embodiment, a computing system may include: a processor configured to perform a plurality of linear computations based on at least one of a first input value inputted to an artificial intelligence model or a first intermediate value calculated on the basis of the first input value and a previously stored model parameter; and at least one memory device including a computing circuit that performs an attention computation based on at least one of a first computation value calculated by at least some of the plurality of linear computations or a second intermediate value calculated on the basis of the first computation value and provides a second computation value according to the attention computation.

In an embodiment, a memory device may include: a plurality of core dies; and a base die configured to transmit and receive data through a first data path and a second data path to and from the plurality of core dies, provide data for a linear computation by a processor located outside through the first data path, and perform an attention computation using data transmitted and received through the second data path.

According to embodiments of the present disclosure, a computation result is provided by separately performing a computation according to an artificial intelligence model depending on a type, whereby the performance of the computation using an artificial intelligence model may be improved to improve the performance of a system.

The effects of the disclosure are not limited to the foregoing objects, and other effects will be apparent to one of ordinary skill in the art from the following detailed description.

### BRIEF DESCRIPTION OF THE DRAWINGS

The disclosure will be more fully understood from the following detailed description and the accompanying drawings, which are provided for illustration only and are not intended to limit the disclosure.

FIG. 1 is a diagram illustrating an example of the schematic configuration of a processing unit according to embodiments of the present disclosure.

FIG. 2 and FIG. 3 are diagrams illustrating an example of a method in which the processing unit according to the embodiments of the present disclosure performs a computation using an artificial intelligence model.

FIG. 4 is a diagram illustrating an example of the schematic configuration of a computing system according to embodiments of the present disclosure.

FIG. 5 is a diagram illustrating an example of the schematic configuration of a second processing unit included in the computing system illustrated in FIG. 4.

FIG. 6 and FIG. 7 are diagrams illustrating an example of a method in which the computing system according to the embodiments of the present disclosure performs a computation using an artificial intelligence model.

FIG. 8 is a diagram illustrating another example of the schematic configuration of the processing unit according to the embodiments of the present disclosure.

FIG. 9 is a diagram illustrating examples of a method in which the computing system according to the embodiments of the present disclosure performs a computation using an artificial intelligence model depending on the type of the computing system.

### DETAILED DESCRIPTION

In the following description of examples or embodiments of the present disclosure, reference will be made to the accompanying drawings in which it is shown by way of illustration specific examples or embodiments that can be implemented, and in which the same reference numerals and signs can be used to designate the same or like components even when they are shown in different accompanying drawings from one another. Further, in the following description of examples or embodiments of the present disclosure, detailed descriptions of well-known functions and components incorporated herein will be omitted when it is determined that the description may make the subject matter in some embodiments of the present disclosure rather unclear. The terms such as “including”, “having”, “containing”, “constituting” “make up of”, and “formed of” used herein are generally intended to allow other components to be added unless the terms are used with the term “only”. As used herein, singular forms are intended to include plural forms unless the context clearly indicates otherwise.

Terms, such as “first”, “second”, “A”, “B”, “(A)”, or “(B)” may be used herein to describe elements of the present disclosure. Each of these terms is not used to define essence, order, sequence, or number of elements etc., but is used merely to distinguish the corresponding element from other elements.

When it is mentioned that a first element “is connected or coupled to”, “contacts or overlaps” etc. a second element, it should be interpreted that, not only can the first element “be directly connected or coupled to” or “directly contact or overlap” the second element, but a third element can also be “interposed” between the first and second elements, or the first and second elements can “be connected or coupled to”, “contact or overlap”, etc. each other via a fourth element. Here, the second element may be included in at least one of two or more elements that “are connected or coupled to”, “contact or overlap”, etc. each other.

When time relative terms, such as “after,” “subsequent to,” “next,” “before,” and the like, are used to describe processes or operations of elements or configurations, or flows or steps in operating, processing, manufacturing methods, these terms may be used to describe non-consecutive or non-sequential processes or operations unless the term “directly” or “immediately” is used together.

In addition, when any dimensions, relative sizes etc. are mentioned, it should be considered that numerical values for an elements or features, or corresponding information (e.g., level, range, etc.) include a tolerance or error range that may be caused by various factors (e.g., process factors, internal or external impact, noise, etc.) even when a relevant description is not specified. Further, the term “may” fully encompasses all the meanings of the term “can”.

Hereinafter, various embodiments of the present disclosure will be described in detail with reference to accompanying drawings.

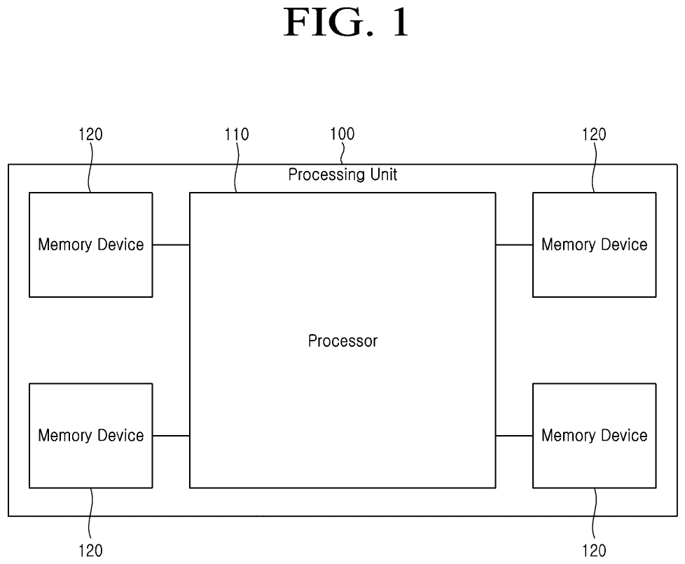

FIG. 1 is a diagram illustrating an example of the schematic configuration of a processing unit 100 according to embodiments of the present disclosure.

Referring to FIG. 1, the processing unit 100 according to the embodiments of the present disclosure may include a processor 110 and at least one memory device 120.

The processor 110 may perform a computation using the one or more memory devices 120. The processor 110 may store data in the one or more memory devices 120, and may read data stored in the one or more memory devices 120 and perform a computation on the read data. The processor 110 may store result data according to the computation performed on the read data in the one or more memory devices 120.

The one or more memory device 120 may include, for example, volatile memory such as Dynamic Random Access Memory (DRAM), Synchronous DRAM (SDRAM), Dual Data Rate (DDR) SDRAM, Low Power DDR (LPDDR) SDRAM, Graphics DDR (GDDR) SDRAM, or High Bandwidth Memory (HBM), but embodiments of the present disclosure are not limited thereto. The memory devices 120 may include nonvolatile memory such as NAND flash memory, 3D NAND flash memory or NOR flash memory.

As the case may be, some of the memory devices 120 included in the processing unit 100 may be volatile memory, and others may be nonvolatile memory. The processor 110 may perform a computation using volatile memory, and may store a part of data stored in the volatile memory in nonvolatile memory as needed. In such a case, a part of a computation function to be performed by the processor 110 may be performed in the volatile memory or the nonvolatile memory.

In addition, the memory device 120 may be one of various types of memory such as resistive RAM, phase change memory, magnetoresistive memory, ferroelectric memory or spin transfer torque memory. As the case may be, the memory device 120 may be a processing-in-memory (PIM) device that includes a computation function or a data processing function as in the examples described above.

The types and combinations of the memory devices 120 included in the processing unit 100 according to the embodiments of the present disclosure are not limited to the examples described above, and various memory devices 120 that may be used for a computation by the processor 110 may be included in the processing unit 100.

The processing unit 100 may be, for example, a central processing unit (CPU), a graphics processing unit (GPU), a neural processing unit (NPU), etc., but is not limited thereto. Depending on the type of the processing unit 100, the function of the processor 110 included in the processing unit 100 may be various.

For example, the processor 110 may include a control unit and an arithmetic logic unit to provide a processing function suitable for a complex computation. Alternatively, the processor 110 may include a plurality of arithmetic logic units and provide a processing function suitable for a computation on a simple and large amount of data. Alternatively, the processor 110 may be designed to be capable of performing an artificial intelligence computation more efficiently by providing a processing function suitable for the artificial intelligence computation.

The processing unit 100 may perform various computations using the processor 110 and the memory devices 120, and may perform a computation using an artificial intelligence model and provide result data according to the computation.

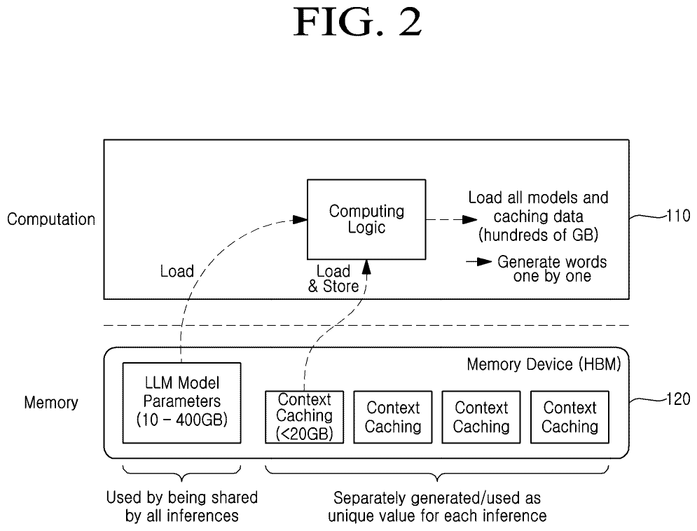

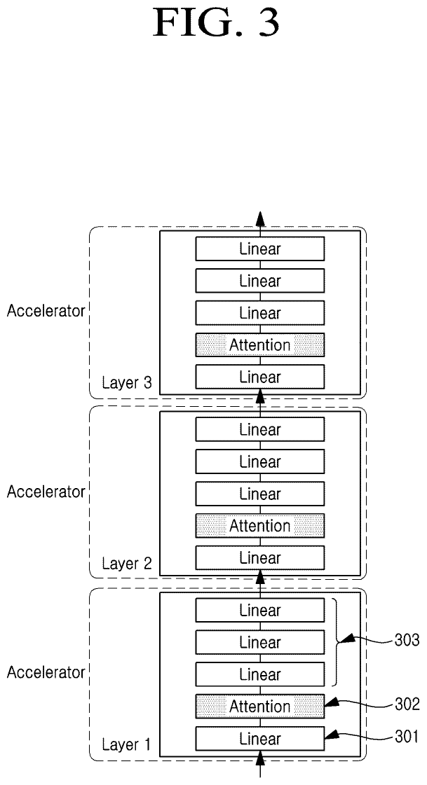

FIG. 2 and FIG. 3 are diagrams illustrating an example of a method in which the processing unit 100 according to the embodiments of the present disclosure performs a computation using an artificial intelligence model.

Referring to FIG. 2, the processing unit 100 may perform a computation for learning an artificial intelligence model or a computation for inference using a learned artificial intelligence model. When performing a computation for inference using an artificial intelligence model, the processing unit 100 may perform a computation using a model parameter stored according to a learned artificial intelligence model. In addition, the processing unit 100 may perform a computation using an intermediate value generated by a computation for inference using an artificial intelligence model.

For example, a computing logic included in the processor 110 of the processing unit 100 may perform a computation using an artificial intelligence model by using data stored in the memory device 120.

The memory device 120 may store a model parameter according to learning of an artificial intelligence model. The amount of the model parameter may be various, and, for example, 10 to 400 GB of model parameter may be stored in the memory device 120. The model parameter stored in the memory device 120 may be used in all inference computations using the artificial intelligence model.

The processor 110 may perform a computation by loading the model parameter stored in the memory device 120. A computation performed by the processor 110 using a value inputted to an artificial intelligence model and a previously stored model parameter may be referred to as a linear computation. The processor 110 may perform a plurality of linear computations during the process of performing a computation for inference of an artificial intelligence model.

The processor 110 may perform a computation using a value inputted to an artificial intelligence model, an intermediate value generated according to a computation for inference of an artificial intelligence model, etc. The intermediate value generated according to a computation for inference of an artificial intelligence model may be referred to as context caching data. The processor 110 may store context caching data generated during an inference process in the memory device 120. The processor 110 may load the context caching data stored in the memory device 120 and perform a computation using the context caching data. A computation performed by the processor 110 using context caching data generated during an inference computation process may be referred to as an attention computation. The processor 110 may perform an attention computation while performing a plurality of linear computations. The attention computation may be used to compute weights corresponding to the relative importance of elements of inputs or of intermediate values of the artificial intelligence model, such as may be known in the related arts.

The processor 110 may provide a result value according to an inference computation of an artificial intelligence model through a plurality of linear computations and an attention computation. The processor 110 may perform a computation through a plurality of computation layers and provide a result value.

For example, referring to FIG. 3, an example of a process in which the processor 110 performs an inference computation of an artificial intelligence model is illustrated. The processor 110 may perform an inference computation of an artificial intelligence model by the unit of computation layer. The processor 110 may perform a plurality of linear computations in each computation layer. The processor 110 may perform at least one attention computation in each computation layer. The processor 110 may perform an attention computation between linear computations to be performed.

For example, referring to computations performed by the processor 110 in a first computation layer, as indicated by 301, the processor 110 may perform a first group of linear computation. The processor 110 may perform the first group of linear computation using a value inputted to an artificial intelligence model and a model parameter previously stored in the memory device 120. The processor 110 may also perform a linear computation using a first intermediate value, calculated by a computation based on the inputted value and the previously stored model parameter, and the previously stored model parameter. The first group of linear computation may include at least one linear computation.

The processor 110 may calculate a first computation value according to the first group of linear computation. As indicated by 302, the processor 110 may perform an attention computation on the basis of the first computation value. The processor 110 may perform the attention computation using the first computation value or a second intermediate value calculated on the basis of the first computation value. The processor 110 may calculate a second computation value according to a result of performing the attention computation.

As indicated by 303, the processor 110 may perform a second group of linear computation on the basis of the second computation value. The second group of linear computation may include at least one linear computation. The processor 110 may perform a linear computation using the second computation value and the previously stored model parameter. The processor 110 may perform a linear computation using a third intermediate value calculated by a linear computation based on the second computation value and the previously stored model parameter. The processor 110 may provide a result value according to a result of performing the second group of linear computation.

A result value may be provided by a plurality of linear computations and at least one attention computation performed by the processor 110. The processor 110 may perform a computation using an artificial intelligence model through the plurality of computation layers. The processor 110 may provide a result value according to a computation for inference of an artificial intelligence model.

In addition, embodiments of the present disclosure may divisionally perform a computation depending on the type of a computation to be performed by the processor 110 to improve the performance of a computation for inference of an artificial intelligence model. In order to improve the performance of a computation for inference of an artificial intelligence model, a plurality of processing units 100 may be provided, or the configuration or operating method of the processor 110 or the memory device 120 included in the processing unit 100 may be changed.

For example, embodiments of the present disclosure may more efficiently perform a computation for inference of an artificial intelligence model by using a plurality of processing units 100.

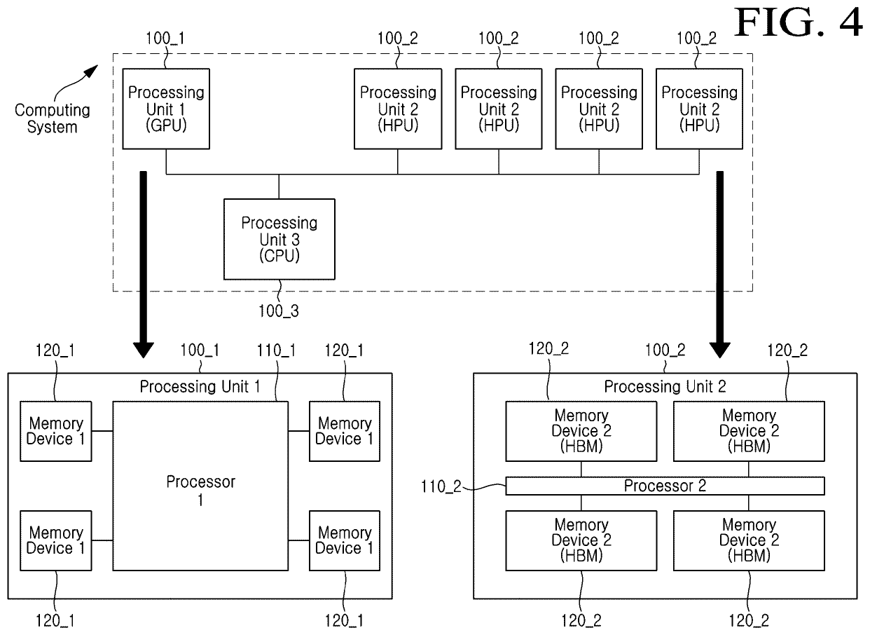

FIG. 4 is a diagram illustrating an example of the schematic configuration of a computing system according to embodiments of the present disclosure.

Referring to FIG. 4, the computing system may include a plurality of processing units 100. For example, the computing system may include a first processing unit 100_1 and a second processing unit 100_2. The computing system 100 may further include a third processing unit 100_3.

The first processing unit 100_1 may include a first processor 110_1 and at least one first memory device 120_1. The second processing unit 100_2 may include a second processor 110_2 and at least one second memory device 120_2.

The computing system may perform a computation for inference of an artificial intelligence model on the basis of a pre-learned and stored artificial intelligence model and a value inputted to the computing system. The computing system may perform a computation using the first processing unit 100_1 or the second processing unit 100_2 depending on the type of a computation for inference of an artificial intelligence model.

For example, the computing system may perform computations using separate processing units 100 by dividing a linear computation and an attention computation among computations for inference of an artificial intelligence model. The computing system may perform a linear computation using the first processing unit 100_1. The computing system may perform an attention computation using the second processing unit 100_2.

The first processing unit 100_1 may include a processor 110 capable of providing higher computation performance than the second processing unit 100_2. The computation performance of the first processor 110_1 may be higher than the computation performance of the second processor 110_2.

The second processing unit 100_2 may provide a memory device 120 with a higher bandwidth than the first processing unit 100_1. At least one of the access bandwidth or capacity of the second memory device 120_2 may be equal to or greater than at least one of the access bandwidth or capacity of the first memory device 120_1.

The first processing unit 100_1 may be, for example, a graphics processing unit. The first processor 110_1 included in the first processing unit 100_1 may include a plurality of arithmetic logic units, and may process a plurality of computations in parallel.

The first memory device 120_1 included in the first processing unit 100_1 may be, for example, HBM, but may also be memory such as GDDR with a smaller access bandwidth or capacity than HBM.

The second processing unit 100_2 may be referred to as a high-bandwidth processing unit. The second processor 110_2 included in the second processing unit 100_2 may include an arithmetic logic unit. Computation performance by the arithmetic logic unit included in the second processor 110_2 may be lower than computation performance by the arithmetic logic unit included in the first processor 110_1.

The second memory device 120_2 included in the second processing unit 100_2 may be, for example, high-bandwidth memory such as HBM. The access speed to the second memory device 120_2 or the capacity of the second memory device 120_2 may be greater than the access speed to the first memory device 120_1 or the capacity of the first memory device 120_1.

For example, the computing system may include a greater number of second processing units 100_2 than first processing units 100_1, but embodiments of the present disclosure are not limited thereto.

The first processing unit 100_1 may perform a linear computation and provide a first computation value. The second processing unit 100_2 may perform an attention computation on the basis of the first computation value and provide a second computation value. The first processing unit 100_1 may perform a linear computation based on the second computation value and provide a result value.

The third processing unit 100_3 may control computations to be performed by the first processing unit 100_1 and the second processing unit 100_2. The third processing unit 100_3 may control data movement between the first processing unit 100_1 and the second processing unit 100_2. The third processing unit 100_3 may be a central processing unit.

The second processing unit 100_2 may be designed to be suitable for an attention computation in an inference computation using an artificial intelligence model. The performance of an attention computation may depend on the performance of the memory device 120, and as in the example described above, the second memory device 120_2 may be high-bandwidth memory such as HBM.

The second processor 110_2 included in the second processing unit 100_2 may be designed to be suitable for performing an attention computation.

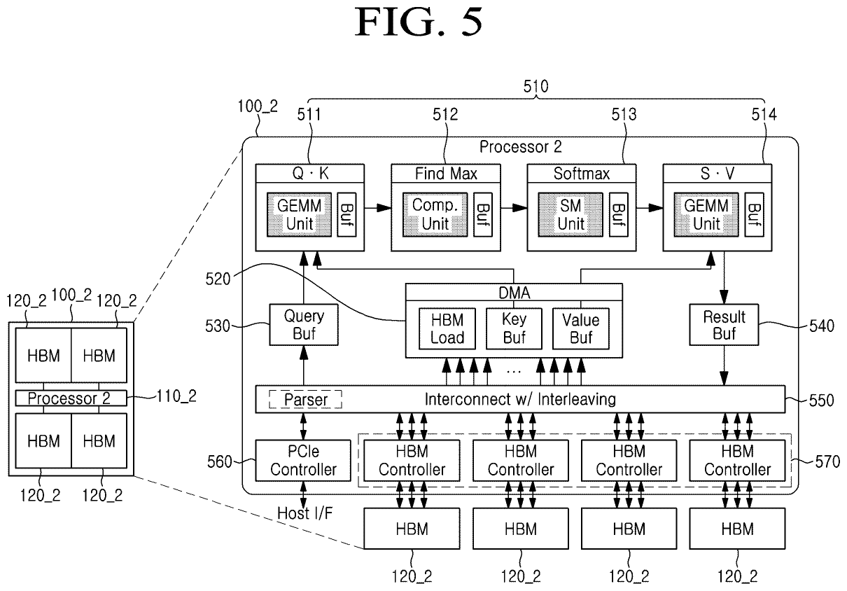

FIG. 5 is a diagram illustrating an example of the schematic configuration of the second processing unit 100_2 included in the computing system illustrated in FIG. 4.

Referring to FIG. 5, the second processor 110_2 of the second processing unit 100_2 may include at least one computation unit 510. The second processor 110_2 may include a direct memory access module 520 and an interconnect unit 550 that control data movement between the second memory device 120_2 and the computation unit 510 and provide a data movement path. The second processor 110_2 may include a query buffer 530 and a result buffer 540 for storing data moved between the second memory device 120_2 and the computation unit 510.

Describing, as an example, a case where the second memory device 120_2 is HBM, the second processor 110_2 may include an HBM controller 570 for controlling the second memory device 120_2. The second processor 110_2 may include a PCIe controller 560 for communicating with a host device. The host device may be the third processing unit 100_3 described above.

The computation unit 510 may include at least one computation circuit. The computation unit 510 may include, for example, a first computation circuit 511, a second computation circuit 512, a third computation circuit 513 and a fourth computation circuit 514. Each computation unit 510 may include a logic section for performing a computation and a buffer for storing data. The computation units 510 may sequentially perform separate computations and provide computation results to other computation units 510.

For example, the first computation circuit 511 may perform a matrix multiplication computation using a value (a query value) inputted to an artificial intelligence model. An input value, a model parameter, etc. loaded from the second memory device 120_2 by the direct memory access module 520 may be provided to the first computation circuit 511. The second computation circuit 512 may perform a computation on the basis of a computation result of the first computation circuit 511 and provide a computation result. The third computation circuit 513 may perform a softmax function computation on the basis of the computation result provided by the second computation circuit 512. The fourth computation circuit 514 may perform a matrix multiplication computation using a computation result provided by the third computation circuit 513. A computation value by the fourth computation circuit 514 may be provided to the result buffer 540.

The configuration of the computation unit 510 may be various, and may be configured with at least one computation unit 510 that is required to perform an attention computation.

The second processor 110_2 may perform an attention computation using a first computation value calculated by the first processor 110_1, and may provide a second computation value according to the attention computation to the first processor 110_1. The first processing unit 100_1 including the first processor 110_1 may be designed to be able to efficiently perform a linear computation, and the second processing unit 100_2 may be designed to be able to efficiently perform an attention computation.

As a linear computation and an attention computation are performed by different types of processing units 100, the performance of a computation for inference of an artificial intelligence model may be improved.

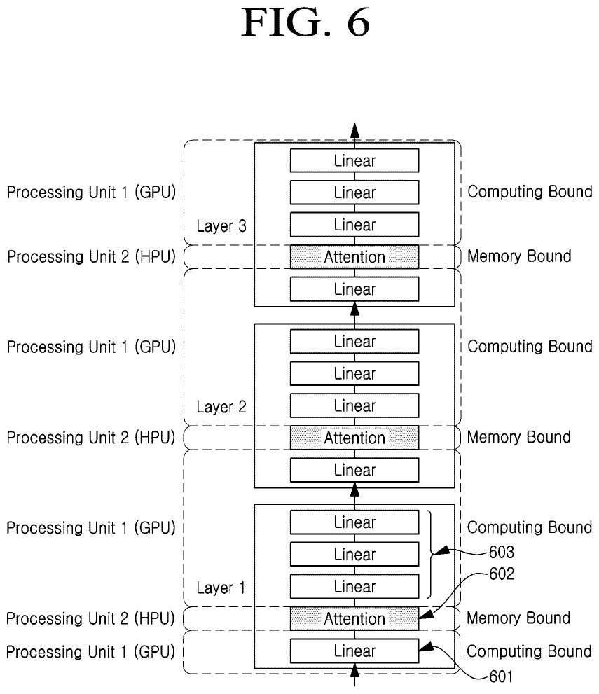

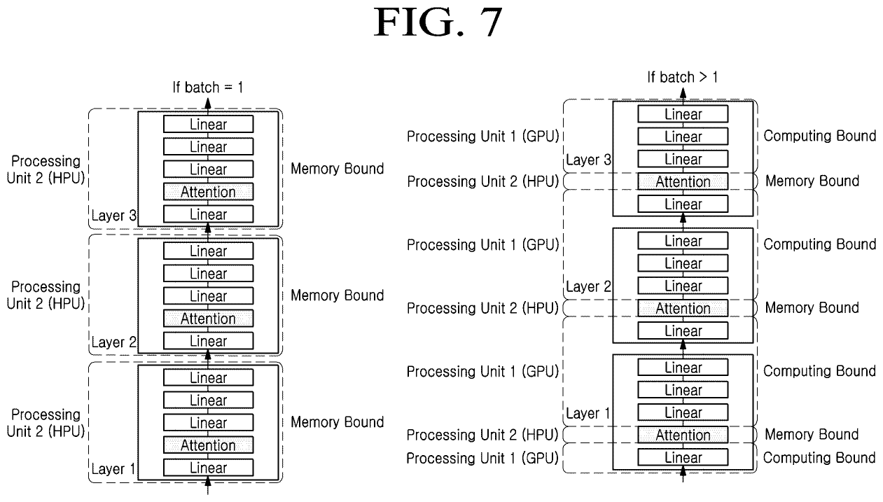

FIG. 6 and FIG. 7 are diagrams illustrating an example of a method in which the computing system according to the embodiments of the present disclosure performs a computation using an artificial intelligence model.

Referring to FIG. 6, computations for a plurality of computation layers may be performed. Each of the plurality of computation layers may include a plurality of linear computations and at least one attention computation. The attention computation may be performed between the plurality of linear computations.

A linear computation may be a computation that requires relatively large amounts of computing power. An attention computation may be a type of computation wherein the performance of the computation is more dependent on the performance of the memory device 120 than on the performance of the processor 110 included in the processing unit 100. Depending on the type of each computation, a computation by the first processing unit 100_1 or the second processing unit 100_2 may be performed.

For example, as indicated by 601, a first group of linear computation may be performed by the first processing unit 100_1. The first processing unit 100_1 may be, for example, a graphics processing unit. The first processor 110_1 included in the first processing unit 100_1 may include a plurality of arithmetic logic units to be capable of performing a plurality of computations in parallel. The first memory device 120_1 included in the first processing unit 100_1 may be high-bandwidth memory such as HBM, but may also be memory such as GDDR with a smaller access bandwidth or capacity than HBM.

On the basis of a first computation value according to the first group of linear computation, an attention computation may be performed as indicated by 602. The attention computation may be performed by the second processing unit 100_2. The second processing unit 100_2, as a unit designed to be suitable for performing an attention computation, may be referred to as a high-bandwidth processing unit. The second processor 110_2 included in the second processing unit 100_2 may have lower computation performance than the computation performance of the first processor 110_1. The second memory device 120_2 included in the second processing unit 100_2 may provide higher bandwidth memory performance than the first memory device 120_1. The second memory device 120_2 may be HBM.

The second processing unit 100_2 may perform an attention computation using the second processor 110_2 that has relatively low computation performance and the second memory device 120_2 that is high-bandwidth memory. The processing performance of the attention computation may be improved compared to when the attention computation is performed by the first processing unit 100_1.

The second processing unit 100_2 may provide a second computation value according to the attention computation to the first processing unit 100_1. As indicated by 603, the first processing unit 100_1 may perform a second group of linear computation on the basis of the second computation value.

A result value may be provided according to the performing of the second group of linear computation. The result value may be provided to a next computation layer. A linear computation included in the next computation layer may be performed by the first processing unit 100_1 in the same manner as the previous computation layer. An attention computation included in the next computation layer may be performed by the second processing unit 100_2.

As a linear computation and an attention computation in a computation for inference of an artificial intelligence model are separately performed by different types of processing units 100, the performance of an inference computation may be improved.

As the case may be, depending on the batch size of data inputted to an artificial intelligence model, processing units 100 that perform a linear computation and an attention computation may be selectively determined.

For example, referring to FIG. 7, when the batch size of data inputted for an inference computation of an artificial intelligence model is 1, a method of performing the inference computation may be different than when the batch size is greater than 1. In an inference computation, a batch may mean a bundle of input data that an artificial intelligence model processes simultaneously. By transmitting a plurality of inputs to an artificial intelligence model at a time and utilizing parallel processing, the performance of an inference computation using an artificial intelligence model may be improved.

When the batch size is greater than 1, performing a linear computation using the first processing unit 100_1 may improve the performance of an inference computation. On the other hand, when the batch size is 1, performing even a linear computation using the second processing unit 100_2 may improve the performance of an inference computation.

When the batch size is greater than 1, the computing system including the first processing unit 100_1 and the second processing unit 100_2 may perform a linear computation using the first processing unit 100_1 and may perform an attention computation using the second processing unit 100_2. When the batch size is 1, the computing system may perform a linear computation and an attention computation using the second processing unit 100_2 in order to improve performance by eliminating the need to move intermediate data from the first processing unit 100_1 to the second performance unit 100_2.

By using the second processing unit 100_2 that provides computation performance and memory performance different from the first processing unit 100_1, only an attention computation may be performed or an attention computation and a linear computation may be performed depending on a batch size, whereby it is possible to improve the performance of an inference computation using an artificial intelligence model.

As the case may be, an attention computation may not be performed by a separate processing unit 100, but may be performed by a component separate from a component that performs a linear computation among components included in a processing unit 100.

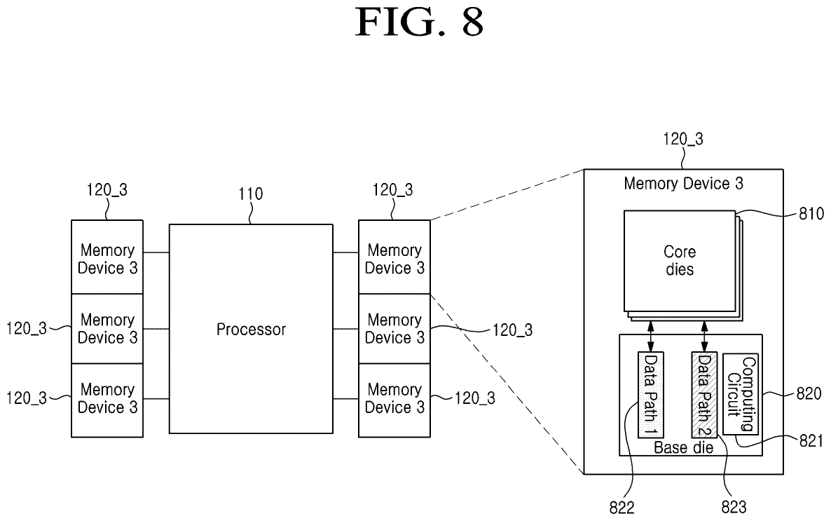

FIG. 8 is a diagram illustrating an example of the schematic configuration of a processing unit 100 according to embodiments of the present disclosure.

Referring to FIG. 8, the processing unit 100 may include a processor 110 and at least one third memory device 120_3. The processor 110 may perform a linear computation in an inference computation using an artificial intelligence model. The third memory device 120_3 may be high-bandwidth memory.

The processor 110 may perform a linear computation in an inference computation using an artificial intelligence model by using the third memory device 120_3.

The third memory device 120_3 may store a first computation value according to the linear computation. The third memory device 120_3 may provide a computation function; for example, the third memory device 120_3 may be a PIM device. The third memory device 120_3 may perform an attention computation based on the first computation value. A second computation value according to the attention computation performed by the third memory device 120_3 may be stored in the third memory device 120_3.

The processor 110 may perform a linear computation by reading the second computation value stored in the third memory device 120_3. The processor 110 may provide a result value according to the linear computation.

The computation function provided by the third memory device 120_3 may be implemented in various ways.

For example, the third memory device 120_3 may include a core die 810 and a base die 820. At least one core die 810 may be disposed on the base die 820, but embodiments of the present disclosure are not limited thereto. A plurality of core dies 810 may be provided, and each core die 810 may include memory cells that store data. In embodiments, each of the core dies 810 may include billions or tens of billions of memory cells. Each of the core dies 810 may include a plurality of word lines and a plurality of bit lines which are electrically coupled with the memory cells. And each of the core dies 810 may include some circuits for driving the plurality of word lines and the plurality of bit lines.

The base die 820 may include an interface for transmitting and receiving data between the third memory device 120_3 and the processor 110. The base die 820 may include at least one data path for transmitting and receiving data to and from the core die 810. The data path may be implemented using, for example, a through-silicon via, but is not limited thereto.

In addition, the base die 820 may include a computing circuit 821 that provides a computation function. The computing circuit 821 may perform an attention computation using data stored in the core die 810. The computing circuit 821 may be implemented to provide computation performance capable of performing an attention computation.

The base die 820 may include a first data path 822 and a second data path 823. Data according to an inference computation of an artificial intelligence model may be transmitted and received through the first data path 822 and the second data path 823.

For example, through the first data path 822, data used for a linear computation in an inference computation using an artificial intelligence model may be transmitted and received. Through the second data path 823, data used for an attention computation in the inference computations using an artificial intelligence model may be transmitted and received.

The first data path 822 may be a path that is included in the base die 820 and is provided for transmitting and receiving data between the processor 110 and the core die 810. The second data path 823 may be a path that is included in the base die 820 and is provided for transmitting and receiving data between the computing circuit 821 and the core die 810.

The third memory device 120_3 and the processor 110 may be disposed on a substrate (e.g., an interposer, a package substrate, etc.), and may be connected to each other through a wiring included in the substrate. The first data path 822 may be connected to the processor 110 through a wiring of the substrate. The second data path 823 may not be connected to a wiring of the substrate.

The processor 110 may perform a linear computation using a value inputted to an artificial intelligence model and a model parameter stored in the third memory device 120_3. The processor 110 may calculate a first computation value according to a linear computation using an input value. In addition, the processor 110 may perform a linear computation using a first intermediate value calculated according to a linear computation using an input value and a previously stored model parameter, and may calculate a first computation value. The processor 110 may store the first computation value according to the linear computation in the third memory device 120_3. The processor 110 may transmit the first computation value through the first data path 822 included in the base die 820 of the third memory device 120_3.

The computing circuit 821 of the base die 820 included in the third memory device 120_3 may perform an attention computation based on the first computation value stored in the core die 810 or a second intermediate value calculated on the basis of the first computation value. The computing circuit 821 may store a second computation value according to the attention computation in the core die 810. The computing circuit 821 may read the first computation value and store the second computation value in the core die 810 through the second data path 823 included in the base die 820.

Because the attention computation is performed by the computing circuit 821 located adjacent to the core die 810, the performance of the attention computation requiring higher memory performance may be improved. In addition, because the computing circuit 821 performs the attention computation by reading the first computation value stored in the core die 810, when a linear computation and an attention computation are divisionally performed, increase in computation time due to movement of data may be prevented or minimized.

The processor 110 may perform a linear computation using the second computation value stored in the core die 810 according to the attention computation by the computing circuit 821 and the previously stored model parameter. The processor 110 may provide a result value according to the performing of the linear computation.

Because the processor 110 performs only a linear computation in an inference computation using an artificial intelligence model and an attention computation is performed by the computing circuit 821 included in the third memory device 120_3, the performance of the attention computation may be improved compared to a case where the attention computation is performed by the processor 110, and the performance of the inference computation of the artificial intelligence model by the processing unit 100 may be improved.

An inference computation using an artificial intelligence model may be performed at various timings depending on the type of the computing system or the processing unit 100. In addition, the timing of an inference computation may be various depending on the configuration of the processing unit 100 included in the computing system, the batch size of data as a target of a computation, etc.

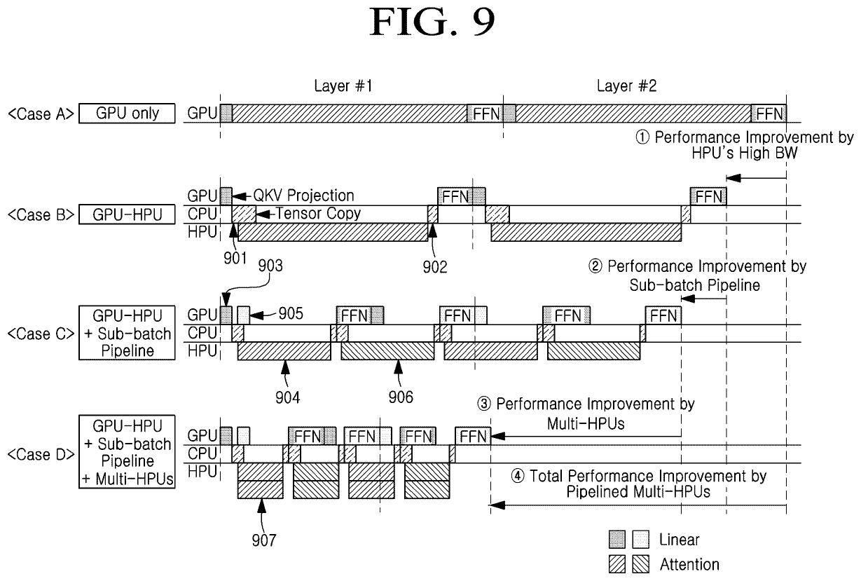

FIG. 9 is a diagram illustrating examples of a method in which the computing system according to the embodiments of the present disclosure performs a computation using an artificial intelligence model depending on the type of the computing system.

Referring to FIG. 9, an inference computation using an artificial intelligence model may be performed only by a graphics processing unit, or may be performed by a graphics processing unit and a high-bandwidth processing unit. In the present specification, the graphics processing unit may mean the first processing unit 100_1. In the present specification, the high-bandwidth processing unit may mean the second processing unit 100_2.

<Case A> represents a case where an inference computation is performed by a graphics processing unit. A linear computation and an attention computation may be performed by the graphics processing unit. The graphics processing unit may be an electronic circuit that is designed to be suitable for performing a linear computation. The overall computation period may increase according to performing of an attention computation.

<Case B> represents a case where an inference computation is performed by a graphics processing unit and a high-bandwidth processing unit.

A linear computation based on an input value and a previously stored model parameter may be performed by the graphics processing unit. A first group of linear computation may be performed by the graphics processing unit, and a first computation value according to the first group of linear computation may be provided.

When the calculation of the first computation value is completed, as indicated by 901, the first computation value may be transmitted to the high-bandwidth processing unit. The first computation value may be transmitted to the high-bandwidth processing unit under the control of a central processing unit.

The high-bandwidth processing unit may perform an attention computation on the basis of the received first computation value. The high-bandwidth processing unit may start the attention computation after completing the reception of the first computation value. Alternatively, as in the example illustrated in FIG. 9, the attention computation may be started while receiving the first computation value. An attention computation may be started using a part of the first computation value that is received, and an attention computation on a remaining part of the first computation value that is received may be sequentially performed. There may be a time interval between a period in which the first group of linear computation is performed and a period in which the attention computation is performed.

When the attention computation by the high-bandwidth processing unit is completed, a second computation value according to the attention computation may be provided. The second computation value may be transmitted to the graphics processing unit under the control of the central processing unit. The graphics processing unit may perform a second group of linear computation on the basis of the second computation value and the previously stored model parameter. As indicated by 902, when the attention computation is completed, the second computation value is moved, and, when the movement of the second computation value is completed, the second group of linear computation may be performed. There may be a time interval between a period in which the attention computation is performed and a period in which the second group of linear computation is performed.

The computing system may perform the linear computation and the attention computation using the graphics processing unit and the high-bandwidth processing unit, respectively, and may complete an inference computation corresponding to a computation layer #1. Because the attention computation is performed by the high-bandwidth processing unit, the time required for the attention computation may be reduced. Although a time may increase due to the movement of data between the graphics processing unit and the high-bandwidth processing unit between the periods in which the linear computation and the attention computation are performed, the overall computation time may decrease due to reduction in a time required for the attention computation.

In addition, by performing a computation by dividing a batch size, as the unit size of data on which a computation is performed, into sub-batch sizes, the computing system may further reduce a time required for a computation.

For example, as in <Case C>, an inference computation may be performed by a graphics processing unit and a high-bandwidth processing unit. The graphics processing unit may perform a linear computation and provide a first computation value according to the linear computation to the high-bandwidth processing unit.

The graphics processing unit may perform a first group of linear computation on data according to a sub-batch size. As indicated by 903, the first group of linear computation may be performed on the data corresponding to the sub-batch size by the graphics processing unit, and a first computation value may be provided to the high-bandwidth processing unit.

As indicated by 904, the high-bandwidth processing unit may perform an attention computation on the basis of the first computation value. The high-bandwidth processing unit may start the attention computation while receiving the first computation value. There may be a time interval between a period in which the first group of linear computation is performed and a period in which the attention computation is performed.

After providing the first computation value for data according to the sub-batch size, the graphics processing unit may perform a first group of linear computation on the remaining data according to the sub-batch size. As indicated by 905, the graphics processing unit may perform the first group of linear computation. The corresponding linear computation may be performed after the previously performed linear computation is completed. During a period in which the first computation value according to the previously performed linear computation is transmitted to the high-bandwidth processing unit, the first group of linear computations on the remaining data may be started.

A second computation value according to the attention computation by the high-bandwidth processing unit may be provided to the graphics processing unit. Upon receiving the second computation value, the graphics processing unit may perform a second group of linear computation based on the second computation value.

The graphics processing unit may transmit a first computation value calculated by the first group of linear computation performed on the remaining data according to the sub-batch size, to the high-bandwidth processing unit. As indicated by 906, an attention computation by the high-bandwidth processing unit may be performed. At least a portion of a period in which the attention computation is performed may overlap a period in which the second group of linear computation is performed by the graphics processing unit.

Because an attention computation is performed by a high-bandwidth processing unit and a linear computation to be performed by a graphics processing unit is performed on each data according to a sub-batch size, at least portions of periods in which the linear computation and the attention computation are performed may overlap each other. A period in which the linear computation and the attention computation are simultaneously performed may be present, and the overall time required for an inference computation may be reduced.

Furthermore, by performing a linear computation and an attention computation on data according to a sub-batch size as in the example described above and by disposing a plurality of high-bandwidth processing units, the time required for an inference computation may be further reduced.

For example, as in an example illustrated in <Case D>, a linear computation may be performed on each data according to a sub-batch size, and a first computation value may be provided to a high-bandwidth processing unit. The first computation value may be transmitted to a plurality of high-bandwidth processing units by being divided. As indicated by 907, an attention computation may be performed by the plurality of high-bandwidth processing units. The time required for the attention computation may be further reduced.

As a second computation value according to the computation by the high-bandwidth processing unit is transmitted to the graphics processing unit, a linear computation may be performed, and a result value may be provided. While divisionally performing a linear computation and an attention computation, through performing a computation on each data according to a sub-batch size and an attention computation using a plurality of high-bandwidth processing units, the overall time required for an inference computation may be further reduced.

According to embodiments of the present disclosure, when performing an inference computation using an artificial intelligence model, a linear computation and an attention computation are performed by separate processors 110, whereby it is possible to reduce the time required for an overall computation and improve the performance of the inference computation.

In addition, as the case may be, by causing an attention computation to be performed in the memory device 120, increase in time due to movement of a computation value of a linear computation and a computation value of the attention computation may be minimized, and the performance of an inference computation may be improved.

Although various embodiments of the present disclosure have been described with particular specifics and varying details for illustrative purposes, those skilled in the art will appreciate that various modifications, additions and substitutions may be made based on what is disclosed or illustrated in the present disclosure without departing from the spirit and scope of the present disclosure as defined in the following claims.

What is claimed is:

1. A computing system comprising:
a first processing unit including a first memory device and a first processor, the first processor configured to perform, using the first memory device, a plurality of linear computations based on:
at least one of a first input value inputted to an artificial intelligence model and a first intermediate value calculated on the basis of the first input value, and
a previously stored model parameter; and
a second processing unit including a second memory device and a second processor, the second processor configured to:
perform, using the second memory device, an attention computation based on at least one of a first computation value calculated using the plurality of linear computations and a second intermediate value calculated on the basis of the first computation value, and
provide a second computation value according to the attention computation.

2. The computing system according to claim 1, wherein the second processor receives the first computation value calculated by a first group of linear computations among the plurality of linear computations, calculates the second computation value on the basis of the first computation value, and provides the second computation value as a second input value for a second group of linear computations among the plurality of linear computations.

3. The computing system according to claim 2, wherein, when receiving the second computation value, the first processor performs the second group of linear computations on the basis of the second computation value and the previously stored model parameter, and provides a result value according to the second group of linear computations.

4. The computing system according to claim 1, wherein the second processor starts the attention computation during a period of receiving the first computation value.

5. The computing system according to claim 1, wherein the second processor performs the attention computation during a period in which the plurality of linear computations are performed by the first processor.

6. The computing system according to claim 1, wherein the second processor performs the attention computation during a second period that is distinguished from a first period in which the plurality of linear computations are performed by the first processor, and there is a time interval between the first period and the second period.

7. The computing system according to claim 1, wherein the first processor performs the plurality of linear computations during at least a partial period of a period in which the attention computation is performed by the second processor.

8. The computing system according to claim 1, wherein the first processor is a graphics processing unit, and the second processor includes at least one matrix operator circuit, at least one softmax function operator circuit, and a comparator.

9. The computing system according to claim 1, wherein the second processor outputs the second computation value to the first processor when a batch size according to data inputted to the artificial intelligence model is larger than a preset threshold size, and performs at least one linear computation based on the second computation value when the batch size is equal to or smaller than the preset threshold size.

10. The computing system according to claim 1, further comprising
a third processing unit configured to control operations of the first processing unit and the second processing unit, and control transmission of the first computation value and the second computation value between the first processing unit and the second processing unit.

11. The computing system according to claim 1, wherein the second processing unit connected to the first processing unit includes a plurality of processing units.

12. The computing system according to claim 1, wherein the second memory device has a substantially higher bandwidth than the first memory device.

13. A computing system comprising:
a processor configured to perform a plurality of linear computations based on at least one of a first input value inputted to an artificial intelligence model or a first intermediate value calculated on the basis of the first input value and a previously stored model parameter; and
a memory device including a computing circuit, the computing circuit configured to:
perform an attention computation based on at least one of a first computation value calculated using the plurality of linear computations or a second intermediate value calculated on the basis of the first computation value, and
provide a second computation value according to the attention computation.

14. The computing system according to claim 13, wherein the processor transmits and receives data for the plurality of linear computations through a first data path included in the memory device, and the computing circuit transmits and receives data for the attention computation through a second data path included in the memory device.

15. The computing system according to claim 13, wherein the processor stores a first computation value calculated by a first group of linear computations among the plurality of linear computations, in the memory device, reads the second computation value from the memory device, and performs a second group of linear computations among the plurality of linear computations.

16. The computing system according to claim 15, wherein the memory device starts the attention computation during a period in which the first computation value is received, and the processor starts the second group of linear computations after reception of the second computation value is completed.

17. The computing system according to claim 13, wherein the memory device comprises:
a base die including the computing circuit; and
a plurality of core dies disposed on the base die, each core die including memory cells that store data.

18. A memory device comprising:
a plurality of core dies; and
a base die configured to:
transmit and receive data through a first data path and a second data path to and from the plurality of core dies,
provide data for a linear computation by a processor located outside through the first data path, and
perform an attention computation using data transmitted and received through the second data path.

19. The memory device according to claim 18, wherein the base die performs the attention computation using a first computation value calculated by the linear computation, and provides a second computation value calculated by the attention computation as an input value for the linear computation.

20. The memory device according to claim 19, wherein a period in which the second computation value is calculated by the attention computation is distinguished from and is continuous to a period in which the first computation value is calculated by the linear computation.
